(19) United States
(12) Patent Application Publication
(10) Pub. No.: US 2004/0025039 A1
(43) Pub. Date: Feb. 5, 2004

(54) Lock box security system with improved communication

(76) Inventors: Adam Kuenzi, Salem, OR (US); Susan Langford, Sunnyvale, CA (US); Ron Chapin, Gervais, OR (US); John Buckley, Turner, OR (US); Dirk L Bellamy, Salem, OR (US); Anton K Diedrich, Mountain View, CA (US)

Correspondence Address: KLARQUIST SPARKMAN, LLP, 121 SW SALMON STREET, SUITE 1600, PORTLAND, OR, 97204, US

(21) Appl. No.: 10/363,938

(22) PCT Filed: Apr. 30, 2002
(86) PCT No.: PCT/US02/13653

(51) Int. Cl. G06F 12/14

(52) U.S. Cl. 713/193

(57) ABSTRACT

Security systems and methods control access at remote locations protected by electronic locks. Users open or otherwise manipulate an electronic lock via an electronic key device. The electronic key device may be an open architecture PDA programmed to function as an electronic key device, while retaining its general-purpose PDA functionality. Alternatively, the electronic key device may be a special-purpose device designed to function as an electronic key device. The key device and the lock box communicate with each other, preferably, by infrared techniques. The lock box and the key device are administered by a central authority via a central computer, which coordinates all security measures through the use of, e.g., frequent updates; tokens that the key device cannot read; checksums, including Message Authentication Codes; and encryption. A plurality of key devices may be programmed to open the same lock box. A key device may open a plurality of lock boxes.

### FIELD

The system and methods of this application concern the field of secure communications between electronic devices through the use of software. More particularly, this application relates to secure communications among electronic devices, including a portable electronic key device carried by a user, an electronic lock at a remote location (e.g., a lock box or other electronic lock), and a central authority.

### BACKGROUND

In order to view the interior of a home for sale, real estate agents and potential buyers traditionally had to arrange with the listing agent or owner to meet them at the home at a particular time in order to be let in. If the schedules of the several people did not coincide, the viewing opportunity could be lost.

In order to make viewing the interiors of homes for sale more convenient, a lock box system is now widely used by real estate agents. In this system, a conventional key to the home is held in a lock box device that is secured to or near the door of the home, e.g., by a shackle. Real estate agents carry electronic key devices, sometimes referred to simply as “keys,” that interact with and communicate credentials, e.g., the identity of the key device and, in some cases, the identity of the “key holder,” to the lock box. If these credentials are accepted, the lock box opens and allows access to the conventional key. Various commands can be entered into the key device to perform various functions. The lock box and the key device are administered by a central authority, which may be associated with a local real estate board or real estate agency. U.S. Pat. Nos. 4,766,746 and 5,046,084, and co-pending U.S. patent application Ser. No. 09/312,919, describe previous generations of such a system. Each of these references is owned by the assignee of the present application and is incorporated herein by reference.

As discussed above, the system comprises three parts, i.e. a central computer under control of the central authority, a key device, and a lock box. In the earliest generations of the system, the key device was a portable, dedicated electronic device that mechanically mated with the lock box to establish direct electrical contact and allow entry of a user code for the particular lock box. Other codes included a personal identification number for the real estate agent using the key device. The key device could also read certain information from the lock box and communicate it back to the central computer, such as the identification numbers of key devices that had gained access to the lock box during a particular period. The key device communicated with the central computer by (1) placing the key device in a proprietary stand that enabled two-way communication between the key device and the central computer, or (2) holding the key device up to the mouthpiece of a conventional telephone and communicating information via the telephone line using DTMF tones or FSK tones.

In a later generation of the system, the key device could be any off-the-shelf personal digital assistant (PDA)-type device. The PDA was inserted into a case having a separate security circuit and mechanical mating elements to mate with the lock box by direct electrical contact in order to open it upon the correct codes being entered into the PDA. As with the earlier generation, the key device could read certain information from the lock box and communicate it back to the central computer.

As described above, each of these versions of the system requires the use of an extra device to enable communications between the key device and the central computer, i.e. a stand, a telephone, or a case. These extra devices, in turn, provide a measure of security; without the stand or case, communication between the key device and the central computer could not occur. Similarly, requiring physical mating between the key device (or a case for the key device) and the lock box provides a measure of security; without the mating elements on the key device or the case, the lock box could not be opened.

What is needed is a system that does not require an extra device to enable communications between the key device and the central computer, and does not require physical mating between the key device and the lock box, but is still secure. Further, the system should allow the use of an open-architecture PDA-type device or other device with wireless capability, such as a cell phone or a laptop computer, as the key device. In such a system, all communications between the key device and the central computer could occur over the Internet. All communications between the key device and the lock box could be performed by infrared or RF techniques. The difficulty is that, without an extra device being required to enable communications between an off-the-shelf PDA key device or other wireless device and the central computer, and without physical mating being required between an off-the-shelf PDA key device or other wireless device and a lock box, all security has to be done through software, not hardware. A particularly important security concern that must be protected against is that an authorized PDA's memory might be copied to another device, thus allowing an unauthorized user to gain access to the physical key to a listed home.

### SUMMARY

Described herein are security systems and methods for controlling access at remote locations. The remote location is secured by an electronic lock box or other electronic lock. Users open or otherwise manipulate the electronic lock via an electronic key device. The electronic key device may be an open architecture PDA programmed to function as an electronic key device, while retaining its general-purpose PDA functionality. Alternatively, the electronic key device may be a special-purpose device designed to function as an electronic key device. The key device and the lock box communicate with each other, preferably, by infrared techniques. The lock box and the key device are administered by a central authority via a central computer, which coordinates all security measures through the use of, e.g., frequent updates, memory tokens and/or authorization tokens that the key device cannot read, Message Authentication Codes and/or other forms of checksums, and encryption. A plurality of key devices may be programmed to open the same lock box. A single key device may be programmed to open a plurality of lock boxes.

### BRIEF DESCRIPTION OF THE DRAWINGS

FIG. 1 is a schematic diagram showing the connectivity and information exchange between components of the system.

FIG. 2 is a block diagram of a key device and a lock box.

FIG. 3 is a flowchart of security checking between the server and a key device.

FIGS. 4A, 4B, and 4C are flowcharts of security checking routines between a lock box and a key device.

FIG. 5 is a flowchart of a security checking routine on a key device.

FIG. 6 is a pictorial view of an exemplary lock box with a shackle in the closed position.

FIG. 7 is a cross-sectional view showing the internal construction of the lock box of FIG. 6 and the key container thereof in the secured position.

FIG. 8 is a cross-sectional view showing the internal construction of the lock box of FIG. 6 and the key container thereof in the pre-release position.

FIG. 9 is a cross-sectional view showing the internal construction of the lock box of FIG. 6 and the key container thereof in the released position.

FIG. 10 is a cross-sectional view showing the internal construction of the lock box of FIG. 6 with the shackle thereof in the open position.

### DETAILED DESCRIPTION

Described below is a security system for controlling access at remote locations secured by electronic locks by users with portable electronic key devices.

In the following description, the electronic key device is an open architecture personal digital assistant (PDA) programmed to function as an electronic key device, while retaining its general-purpose PDA functionality. Also, at least the communication between the key device and the electronic lock occurs via infrared transmission or another suitable optoelectronic method.

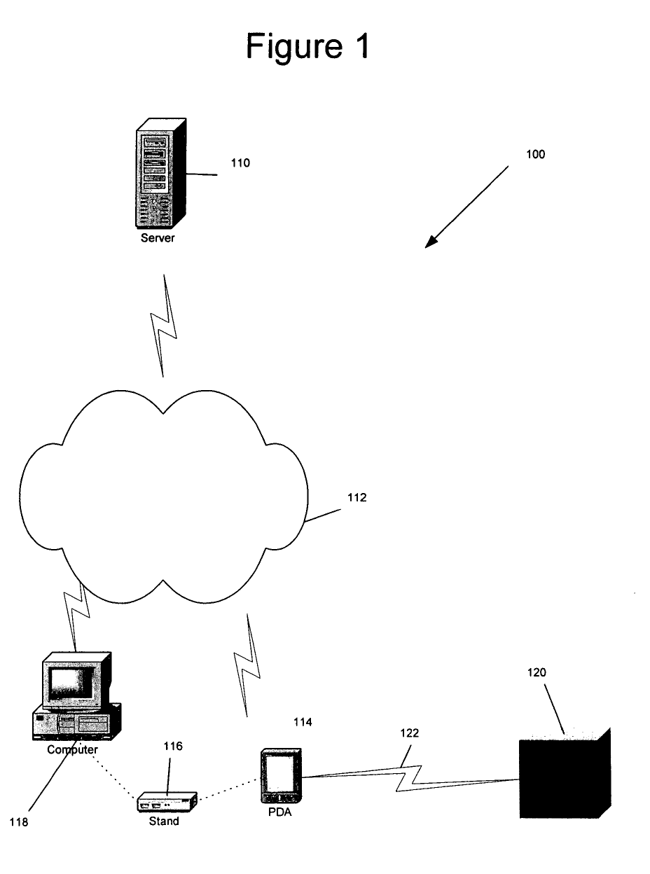

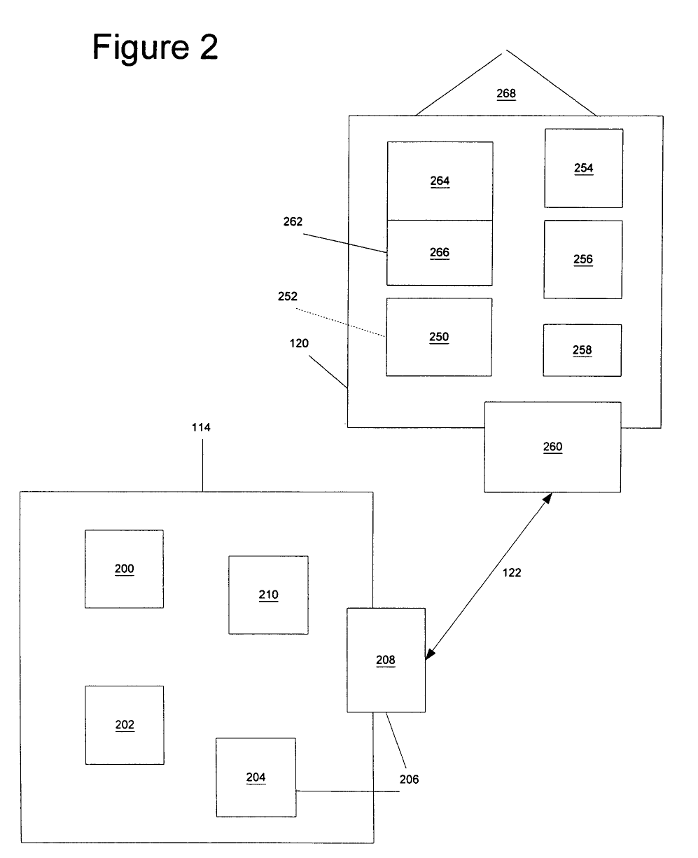

In an exemplary system 100 as shown in FIG. 1, an administrator (represented by a computer or server 110), exchanges information through public and/or private networks 112 with a PDA key device 114. Examples of contemplated public networks include the Internet and the web. The exchange of information may occur through a wired connection or through a wireless connection. An example of a wired connection is depicted in FIG. 1 by the PDA 114 communicating with a stand 116, which communicates with a personal computer 118, which communicates with the server 110 through the network 112 via a modem (not shown) in the personal computer. An example of a wireless connection is depicted in FIG. 1 by the PDA communicating with the server 110 directly through the network 112 via a modem in the PDA (shown at 210 in FIG. 2).

An electronic lock, e.g., an electronic lock box 120, secures a remote location, such as a house or other building (not shown). In addition to the lock box 120, other types of electronic locks receptive to infrared communication and capable of authenticating an access request from a key device are equally suitable for use in the present system.

As indicated by the arrow 122, the key device 114 and the lock box 120 exchange information when a user, called a “key holder” or a “key device user,” visits the remote location and places the key device 114 in proximity with the lock box 120.

Considering the flow of information between the server 110, the key device 114, and the lock box 120, the key device acts as an “intermediary” between the server 110 and its “clients,” e.g., the various locks in the system, such as the lock box 120.

A use of the present system is in the real estate sales industry, where locks such as the lock box 120 can be attached to properties that are available for sale. Such a real estate application is described herein. The present system is also useful in many other situations, however, and is expressly not limited to real estate applications.

Components of Key Device and Lock Box

Turning now to FIG. 2, the key device 114 requires several internal components, each of which is commonly found in a PDA. These include a central processing unit (CPU) 200, a memory 202, a battery 204, and at least one input/output channel 206. The at least one input/output channel 206 preferably comprises at least two input/output channels, including an infrared transceiver 208 and a modem 210.

The lock box 120 also comprises several internal components. As shown in FIG. 2, the lock box 120 comprises a central processing unit (CPU) 250, including a real-time clock 252 within the CPU; at least one battery 254; preferably a second battery 256, a key container 258 for holding at least one conventional key (not shown), an infrared transceiver 260, and a memory 262. Preferably, the memory 262 is partitioned into a secure area 264 and a public area 266. The lock box 120 also comprises an external shackle 268, which is used to secure the lock box 120 to a door or other fixed object (not shown).

The key device 114 and the lock box 120 communicate with each other via the infrared transceivers 208, 260, respectively, as shown by the arrow 122.

One suitable PDA is the Palm Pilot, although any PDA with infrared communications capability can be used. For example, other PDAs using the Palm OS operating system, the Microsoft Windows CE operating system, or similar operating systems could also be used. Further, as noted, other wireless devices, such as cell phones and laptop computers, could also be used. With some devices, RF communication would be used rather than infrared communication. All these devices and communication methods are within the scope of the present system.

Security Concerns

The main security concerns regarding the present system are threefold: first, a clever and cheap real estate agent; second, a competitor; and third, a malicious attempt to break into a lock box.

The concern with a clever real estate agent is that she might be looking for free service. The system includes mechanisms to stop real estate agents from obtaining free information from the server, and from opening lock boxes with a copy of another real estate agent's databases and applications. However, if a “hacked” version of the system or a significant portion thereof is ever developed and distributed, a real estate agent could copy a valid PDA and use the copy for operating the lock box. But, she would still not be able to sync to the server. Daily expiration of memory tokens and update codes would make this method a continual nuisance for the agent.

Regarding the second concern, a competitor might desire to figure out the system and offer a service that is less expensive or otherwise more attractive to users. In this case, the encryption keys can be “rolled,” i.e., changed, to stop a third party from operating the lock box.

Breaking into houses or other properties for sale is a very real concern. However, most common thieves will not try to compromise a lock box, but rather will break a window or “bust in” a door. The third concern is really about malicious attacks against the system. Attacking the system involves reverse engineering the PDA application to get around copy protection, or attempting to crack the encryption keys so that memory tokens can be ‘generated’ and posted on the Internet for anyone to use. This threat is addressed by user lockouts in the lock box, the use of Advanced Encryption Standard (AES) with 128-bit keys, and a way to re-key or roll the system.

As stated, access to the lock box through infrared communication is accomplished by communication between the lock box and a conventional general-use PDA device programmed for this use. Alternatively, a dedicated electronic key equipped with infrared communication capability can be used in place of the PDA. An example of the latter is the assignee's proprietary key device known as DisplayKEY. As used herein, the term “key device” refers to both a general-purpose PDA and a DisplayKey or the like.

Users and lock boxes are identified by unique serial numbers, and are grouped by MLS (Multiple Listing Service). Each MLS is assigned a unique System Code. All agents who belong to a particular MLS can access all of the lock boxes that have the corresponding System Code. Users are authorized to open a lock box through the use of data blocks called “authorization tokens.” As used herein, the term “authorization token” means a data block that contains information to be communicated between devices, such as system codes or other codes, encryption keys, etc. Authorization tokens in the present system are often are not readable by the devices on which they reside, as explained further below, in order to pass information from the server through a key device to a lock box without interference.

Authorization tokens specify what permissions and options each user has within a System Code. Authorization tokens are generally sent to a key device during a synchronization process (sync) to the server. “Sync” refers to an act of the key device communicating with the server to exchange data therewith; this is meant to occur periodically, typically daily. Authorization tokens are formed with strings of plain-text data followed by a Message Authentication Code (MAC) that verifies the contents of the authorization token. (A MAC is a well-known form of checksum.) For security, MACs and other information are encrypted with industry standard algorithms. The Advanced Encryption Standard (AES) with 128-bit keys is the encryption algorithm preferably used, although other encryption algorithms may also be used. Cryptographic keys are different for each System Code, so compromised keys would have limited access to one system only.

Key devices can have multiple authorization tokens simultaneously, so a key device can be used with different System Codes. This is useful if, for instance, a key holder is geographically located near a boundary between MLS territories and sells properties in both territories. However, a lock box can have only one assigned System Code at a time, i.e. it may be assigned to only one MLS at a time. If multiple authorization tokens have the same System Code, the lock box will try them in order one at a time.

The next three sections discuss security issues in the lock box, in the PDA, and in the server.

Lock Box Security

For security, the lock box has three lockout mechanisms.

Obtain Key Lockout—If more than 10 incorrect PINs or Call Before Showing (CBS) Codes have been entered, the box locks up the Obtain Key function for 10 minutes. Other functions operate normally.

Bad Code Lockout—If more than 10 incorrect Shackle Codes or Programming Codes have been entered, the box locks up these functions for 10 minutes.

Bad Authorization Token Lockout—If more than 20 bad authorization tokens are received, the lock box locks up all activity for 10 minutes. “Bad authorization token” means, generally, that the MAC is not correct or that the Update Code is not correct. If the MAC and/or the Update Code are both correct, yet the user is not updated for today's date, this is not considered a bad authorization token; however, the user is not updated to open the box.

There are three operation modes for the lock box. A first mode is a “key” mode. This operation mode is the one most often used by real estate agents, and is described in detail herein. Authorization tokens provide the security in this mode, and a challenge/response is used when the PIN is exchanged.

A second operation mode is a “programming base connection” mode. A programming base is a physical device that connects to a lock box, either physically or by infrared or another communication method, to reprogram it. The programming base connection mode is established by a challenge/response that requires the programming base to know an encryption key, K_{BOX}, that is unique to a given lock box and is programmed into the lock box at the factory. The K_{BOX} is, preferably, stored in EEPROM associated with the CPU 250 of the lock box.

Typically, the programming base will have an on-line connection to the central authority. If the programming base is trusted hardware, the device-unique key K_{BOX} can be saved and used in an off-line mode.

A third operation mode is a “public” mode. If a key device connects to a lock box in the public mode, only a limited number of commands are allowed and only a portion of the lock box's memory that is reserved for such public functions can be read, as described below.

Finally, the encryption keys in a lock box are write-only and the normal Read Memory command is masked off for this portion of the memory map. Generally, the only way to “read” an encryption key out of a lock box is destructive and involves a lot of technology. Similarly, there is generally no “back-door” method for authorizing a key device to gain access to a lock box.

PDA Security

A PDA is the desired device to be used as a key. Several potential security problems are solved by the present system, i.e.,

1. Syncing to the server without authorization

2. Copy protection of PDA applications and data

3. Unauthorized access to lock boxes

The problem of an attempted sync to the server without authorization is solved by using a “rolling code.” A rolling code is a random number generated with each connection to the server and saved as a memory token on the PDA. Memory tokens are non-moveable data chunks that are disassociated from the PDA application and not linked to any application or database. They are not easily re-created on another PDA. Creating this memory token, or establishing the trust relationship from a PDA to the server, is done with a registration process. A unique number must be keyed into the PDA by the user or by installation software at the central authority that will “register” this PDA for the first sync to the server. After the first sync, the rolling code mechanism is in place.

“Copy protection” does not mean that applications and databases cannot be copied from one PDA to another. Rather, it means that, once copied, the applications will fail to operate normally for the user. This is accomplished by the use of memory tokens, as noted.

Three memory tokens are used in the present system: a PDA self-check memory token, a rolling code memory token known only to the server, and an encryption key memory token. The PIN encryption key memory token, K_{PIN}, is encrypted into an authorization token, known only to the server and the lock box, and is used by the lock box in the transfer of the PIN, Shackle Code, or Programming Code from the PDA to the lock box, as described below.

Unauthorized access to lock boxes is solved by using:

1) MACs and a bad code lockout in the key device to resist modifying or generating new memory tokens;

2) a challenge/response to stop infrared recording and playback by another PDA; and

3) the PIN encryption key (K_{PIN}) memory token.

Server Security

The server is critical in the system because it is connected to the Internet and thus vulnerable to sophisticated hacking attempts. Database servers will be protected, including by use of firewalls. Encryption keys, PINs, and rolling codes are stored on the database servers, and thus it is critical to maintain their integrity.

Other Server Issues

Authorization to the server is done with a unique key device-holder serial number, with the System Code, and with the rolling code memory token. The rolling code memory token is used in a challenge/response where the server challenges the PDA by sending a memory location, and the PDA responds by returning the contents of memory at that location. If the data is incorrect, then the PDA is denied service.

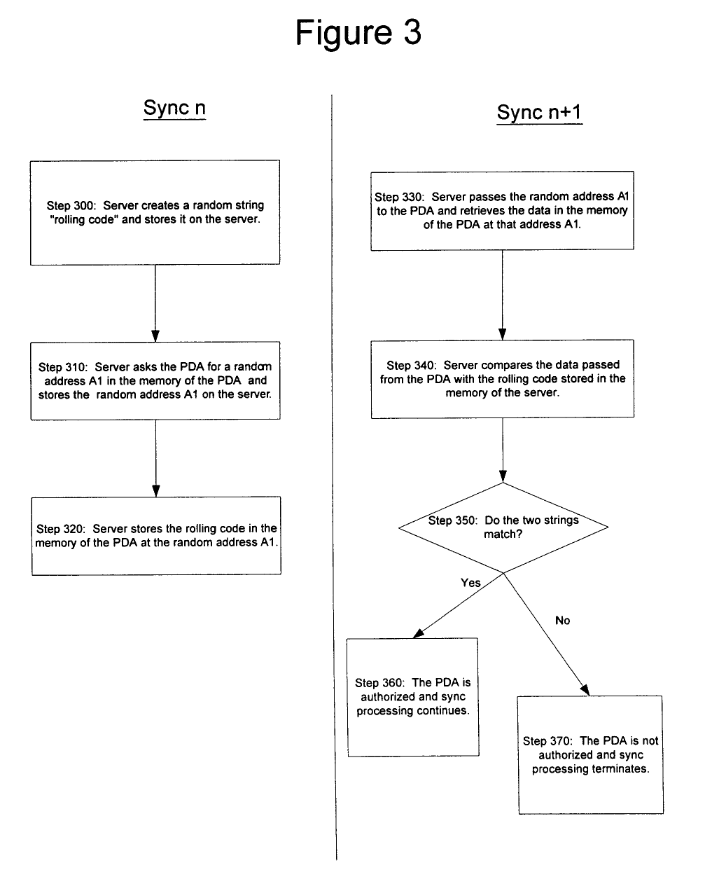

In particular, the rolling code memory token checking works as follows. As shown in FIG. 3, at a given sync between the server and a PDA, shown on the left side of FIG. 3 as sync n, in step 300 the server creates a random string of data called a “rolling code” and stores it on the server. In step 310, the server asks the PDA to select a random address A1 in the memory of the PDA and communicate the address A1 to the server. The server then stores the address A1 on the server. In step 320, the server stores the rolling code on the PDA at the random address A1. At no time is the random address A1 in the memory of the PDA pointed to or used by any other application, making detection or discovery by an outsider extremely difficult.

At the next sync, shown as sync n+1 on the right side of FIG. 3, in step 330 the server passes the random address A1 from the server to the PDA and retrieves the data from the memory of the PDA at the address A1. In step 340, the server compares the data passed from the PDA to the server with the rolling code stored on the server. In step 350, the server asks whether the two strings are the same. If they are the same, this is a good indication that the PDA has not been tampered with and that the PDA that has been presented for sync processing has not been copied from another PDA. In step 360, therefore, the PDA passes the test and sync processing continues. If, however, the compared data strings are not the same as each other, this is a good indication that the memory of the PDA has been tampered with since the last sync, or that the memory of the PDA being presented for sync processing was copied from the memory of another PDA and the copied data did not go to exactly the same address (which is usually the case when copying from one PDA to another). In that case, in step 370, the PDA does not pass the test, and the sync process ends.

Lock Box

The lock box 120 of the present system has most features of the previous generations of lock boxes, plus some additional features. As shown in FIG. 2 and discussed above, important features of the lock box 120 include a key container 258 for holding conventional keys; a shackle 268 for mounting around a door handle or other object; an infrared communication transceiver 260; a central processing unit (CPU) 250; at least one and preferably two internal batteries 254, 256 (preferably primary-lithium batteries having a 5-year life); a real-time clock 252 that is internal to the CPU; and a memory 262. The memory is, preferably, partitioned into secure and public areas 264 and 266, respectively.

The lock box 120 uses IrDA communication. The lock box can include a shackle mounting option, which allows the lock box to be secured to a door handle, fence, gate, etc. The lock box may also be configured for alternative mounting, e.g., with fasteners to a stationary object. Finally, an unsecured PDA can be used to securely access the lock box, providing it has authorization from the server.

Features

The following sections outline the requirements for the lock box firmware.

4-Byte Serial Number

Each lock box has a unique serial number, preferably stored in the secure area 264 of the memory of the lock box. In addition to identifying the lock box during use, the serial number may be used to track maintenance and upgrades. Serial numbers are generally not changed over the life of the lock box. These serial numbers start above the maximum numbers used for serial numbers in previous generations, in order to uniquely identify the present generation.

4-Byte System Code (MLS)

An authorization token gives a user authorization to access the System Code. Mixed sites, i.e. sites with lock boxes from the present system as well as from previous generation(s) will use System Codes compatible with previous generations as well as with the present system.

Security

Challenge/Response

A challenge/response is used when connecting to the lock box. This eliminates infrared copy and playback, and is described in detail below.

Encryption and Decryption

The lock box supports AES with 128-bit encryption keys. Encryption is used to securely transmit data from the server through the key device to the lock box.

Cryptographic Keys

There are three encryption keys saved in the lock box: a system encryption key (K_{SYS}), a previous system encryption key used for rollover (the immediately prior version of K_{SYS}, for which the new K_{SYS} is substituted during the rollover process), and a device-unique encryption key (K_{BOX}). A programming base uses the device-unique encryption key to connect to the lock box in the “Programming Base” mode of operation, as described above.

Real-Time Clock

The real-time clock keeps the time of day and the date in the lock box. The time and the date are used in the lock box security routine.

The time drift is recorded in an access log on an accessing key device and is reported to the server by the accessing key device.

Setting the Clock

The real time clock can only be programmed by knowledge of the Shackle Code or the Programming Code, or as a programming base.

Reading the Clock

The real time clock can be read by anyone.

Battery Maintenance

The lock box has an internal battery. The lock box maintains the following information about the battery in the EEPROM:

Manufactured year and month (for determining life of battery)

Number of openings done in extreme conditions

Number of openings and shackle releases in normal conditions

The lock box will also measure the battery voltage and temperature and then calculate the estimated charge remaining in the battery. The number of openings done in extreme conditions is a factor in estimating the remaining battery life.

The battery status should be saved in the access log of the key device. Battery status can then be reported via e-mail or web-page report to the appropriate person.

Communication

IrDA Physical Layer

The infrared communication will comply with IrDA specifications for the physical layer. These specifications, which are well known to those of ordinary skill in the IrDA art, include wavelength, data rates, and pulse widths.

IrDA Protocol Compliance

The lock box uses IrDA compliant communication for the following IrDA protocols, each of which is well known to those of ordinary skill in the IrDA art: IrDA Link Access Protocol (IrLAP), IrDA Link Management Protocol (IrLMP), and IrDA Data Protocol TinyTP, though other IrDA data protocols may also advantageously be used.

Lock Box Command Protocol

The lock box has a command protocol that is used by IrDA-equipped devices. This protocol is used for all communication functions with the lock box. With this protocol, there is a master/slave relationship with the key device generally being the master and the lock box generally being the slave.

Operation Modes

As discussed above, there are three operation modes for lock boxes: secure, programming base, and public. The public mode is designed to be used for storage of public information, as described below. It is anticipated that one or more applications will be written to allow PDAs to read this information, and that the application(s) will be downloadable from the web.

Commands

Summary of lock box commands that can be sent by infrared:

Read/Write Memory (many software level features are built on these two commands)

Read/Write Real Time Clock

Obtain Key

Release Shackle

Read Last ‘N’ Accesses

Read All Tracking

Verify Codes (PIN, Shackle Code, Programming Code)

Flash Firmware

Flashing the Firmware

The firmware can be updated (“flashed”) in the field.

Key Holder Authorization

There are several components to determining if a key device is authorized.

Authorization Token Validation (Encryption/Decryption Keys)

First, the key device must have an authorization token that corresponds to the System Code of the lock box, or to the serial number of the lock box. The lock box must validate the authorization tokens that are presented by the key device. Not all of the authorization tokens contained within the key device's database will be transmitted. The particular cryptographic key that is used is determined by the type of the authorization token and by the system encryption key version number that is stored within each authorization token.

Update Code Validation

A user can enter an Update Code to update the access period to a lock box, i.e., the dates and times during which the key device is authorized to access the lock box. This can also be thought of as updating the expiration date and time of the authorization token. The Update Code is simply appended to the end of the authorization token.

Copy-Protection Service for PDA Key Application

The PIN encryption key memory token is saved on the key device and is used when sending PIN, Shackle Code, or Programming Code to the lock box. The PIN encryption key memory token is encrypted within an authorization token. The lock box can decrypt the memory token information to use for copy protection.

Lockout on Bad Code/Invalid Memory Token

The lock box has a lockout feature that limits brute-force attacks. There are lockouts for bad PIN, bad codes (Shackle Code, CBS Code, Programming Code), and bad authorization tokens. The only lockout that restricts all operation with the box is the bad authorization token lockout. A lockout occurs when the counter reaches 10 (this number can be programmed in the lock box). The lockout is in effect for 10 minutes (also programmable), and then the counter is reset. The bad PIN and bad code counters are reset back to zero when the correct code is entered. The bad authorization token counter is only reset under two conditions: first, when the lockout has occurred and the 10-minute timeout has expired, and second, when the key container is physically opened (i.e. the memory token was valid and updated).

Serial Number List

This list is, preferably, a lockout list. The key devices on the list are locked out, i.e., not allowed to access the lock box. Alternatively, the serial number list could be configured as an “allowed in” list, i.e., as a list of key devices s that are allowed to operate the lock without needing to be updated. Regardless of which list configuration is used, valid authorization tokens are still required.

Key Container

The key container is the primary feature of a lock box, around which all of the other features of the lock box are built. A key device holder has access to the key container (and the contents thereof) only if they are authorized as explained in the sections above.

Release Key Container

The key container is released after the open command is sent. The user is required to push up on the bottom of the key container with one hand to release the container. A programming base will also be able to send this command.

4-Digit PIN Code Verification

Before releasing the container, the user must enter her 4-digit PIN. The PIN is enforced by the lock box.

7-Digit CBS Code Verification

If either the key device or the lock box requires the key device to communicate the Call Before Showing (CBS) Code, then the CBS Code sent by the key device must match the CBS Code on the lock box. The CBS Code is a random 7-digit code that is fully programmable in the field, e.g., by a MLS.

A lock box might require a key box to send a matching CBS Code if, for instance, a house associated with a given lock box is not available for viewing when the owner is home. The circumstances in which a key box might require a matching CBS Code between the key device and a lock box require a more detailed explanation.

Occasionally, someone other than a real estate agent will require access to a house or commercial structure that is for sale and unoccupied. Examples of persons who might require access include pest inspectors, building inspectors, utility meter readers, etc. To allow such persons, known as “affiliates,” access, they are given key devices that require them to know the CBS Code for each lock box they try to access. In this way, the real estate agent or MLS can give the affiliate a key device and tell her the CBS Code for only one lock box or a small number of lock boxes, in which case she will be able to gain access to only those houses without compromising security for other lock boxes in the area.

Time Access Windows

The key device has 4 timed access windows that set the time of day and the day of the week when the key container can be opened. This feature can be disabled to set the box to 24-hour access.

Permissions

If the memory token contains permissions, this feature will be checked. A “permission” is a string of bytes that is matched on a hierarchical basis (think IP address) and has the capability for permissions per device as well as per structure (i.e. building, floor, room). The string is formatted either byte-wise or bit-wise to form a hierarchy of access. A box will only have one assigned “permission” that a memory token can be compared against.

Log/Count Key Container Openings

Every successful kev container opening is logged with the following information: serial number of the accessing key device, year, month, date, hour, minute, and the key holder's name and telephone number. Unsuccessful accesses are logged in the error log with only the serial number, type of error, and date.

Release Shackle

Any key device that has a valid, non-expired authorization token that authorizes a shackle release can release the shackle of a lock box. After the command is sent to release, the user must wait for up to 13 seconds for the charge-pump to fire the solenoid to release the shackle.

4-Digit Shackle Code Verification

The user must enter a 4-digit Shackle Code before releasing the shackle. If the Shackle Code is incorrect, it counts toward the bad code lockout of the lock box.

Owner Only Verification

If the Owner Only flag is set, only the lock box owner can release the shackle. The lock box owner is the key device that has the serial number that is programmed into the owner slot.

Log/Count Shackle Openings

Every successful Shackle Release is logged with the following information: key device serial number, year, month, date, hour, minute, and the key holder's name and telephone number. Unsuccessful accesses are logged in the error log with only the serial number, type of error, and date.

Access Log & Reading the Log

The access log (as noted above) records the successful shackle and key container openings. Any operations that are unsuccessful are saved in the error log. The access log will log up to approximately 100 accesses.

4-Digit Shackle Code Verification

When reading the access log, a key device with a valid and non-expired authorization token authorizing shackle access must also submit a valid 4-digit Shackle Code. If the Shackle Code is incorrect, it counts toward the bad code lockout of the lock box.

Owner Only Verification

If the Owner Only flag is set, only the owner of the lock box can read the access log.

Reading the Log by a Key Device

The log information can be passed to the key device in several ways. The key device can request only the last successful access, which does not require that the user know the Shackle Code, or the key device can request the entire access log, which does require the Shackle Code.

Log Maintenance

The log is saved in an indexed list with a pointer to the most recent log entry, though other types of lists such as doubly linked lists may also be used. If there is no more memory space for adding new log entries, the list will “roll” and each new entry is written over the oldest existing entry.

Error Log & Diagnostics

The error log is similar to the access log, except that it contains all of the failed operations and error codes. The error log records the last 50 errors.

Reading the Error Log by a Key Device

Any key device having a valid authorization token that authorizes reading of the error log and is not expired can read the error log. The Shackle Code is not required for this operation. The following information is part of the error log: the serial number of the key, the date and time of the error, the error code, and, optionally, the key holder's name and telephone number.

Other Diagnostic Information

Other diagnostics information can also be requested at the same time the error log is read. This includes the RTC time, the battery status, whether or not the lock box is currently in a bad code lockout, the lock box serial number, and the total number of lock and shackle openings.

Error Log Maintenance

The log will be saved in a table with an index pointer to indicate the most recent error. If there is not more space for adding new entries, the log will “roll” and each new entry will be written over the oldest entry.

Lock Box Programming

The lock box is completely programmable at the factory, and only partially programmable in the field.

4-Digit Programming Code

Field programming is done by authorized keys that have entered the correct Programming Code. The Programming Code is a 4-digit code that is separate from the Shackle Code. If an invalid code is entered it counts toward a bad code lockout. If the Programming Code has been set to ‘FFFFFFFF’ in the lock box, then the Shackle Code is checked by the lock box instead.

Owner Only Verification

If the Owner Only Programming flag is set, then the serial number of the key device must match the owner's serial number.

Programming of Lock Box Options and Settings

The settings in the lock box that can be customized or programmed in the field are as follows:

Shackle Code

Programming Code

CBS Code and CBS On/Off

Access Hours

24-Hour access On or Off

Application Information Areas

Real Time Clock

Secure and Public Information Areas (Application Defined)

The lock box has one application information area in its memory that is partitioned into two sub-areas. The first sub-area is a secure information area that can only be read by a key device that has proper server authorization. The second sub-area is public and can be read by any key device or device that has the proper programming. Flags can also be set that allow only the owner of the lock box to program the information.

The format and content of the information is application-specific and is not constrained by the lock box in any way. Examples of the information that can be stored in the authorized sub-area include: listing ID, date of listing, MLS name, listing agent's business card information, pictures, key-box-holder to key-box-holder message, etc. Examples of information that can be stored in the public sub-area include such static data as a promotional message from the listing agent to prospective buyers and pictures, and such dynamic data as a log (sales lead) of registration numbers of keys that have read this information.

Mixed Sites

While the present system is intended to completely replace previous generations over time, lock boxes from previous generations will continue to exist and be used within the present system for some period of time. Thus, codes for the present system must be non-coincident with codes from previous generations.

Key Device—Lock Box Security Checking

As discussed above, a security concern is that an unauthorized key device will be used to open a lock box, which would allow a physical key to a home obtained by an unauthorized person. One of the techniques used to combat this is the use of a Personal Identification Number (PIN). The server maintains a list of the current PIN for each key device. The server created the initial PIN for each key device. A key device user may change the PIN by communicating with the server, preferably through a secure web site. When a key device user changes a PIN, the new PIN is stored on the server. The lock box use the PIN during the verification process as described below.

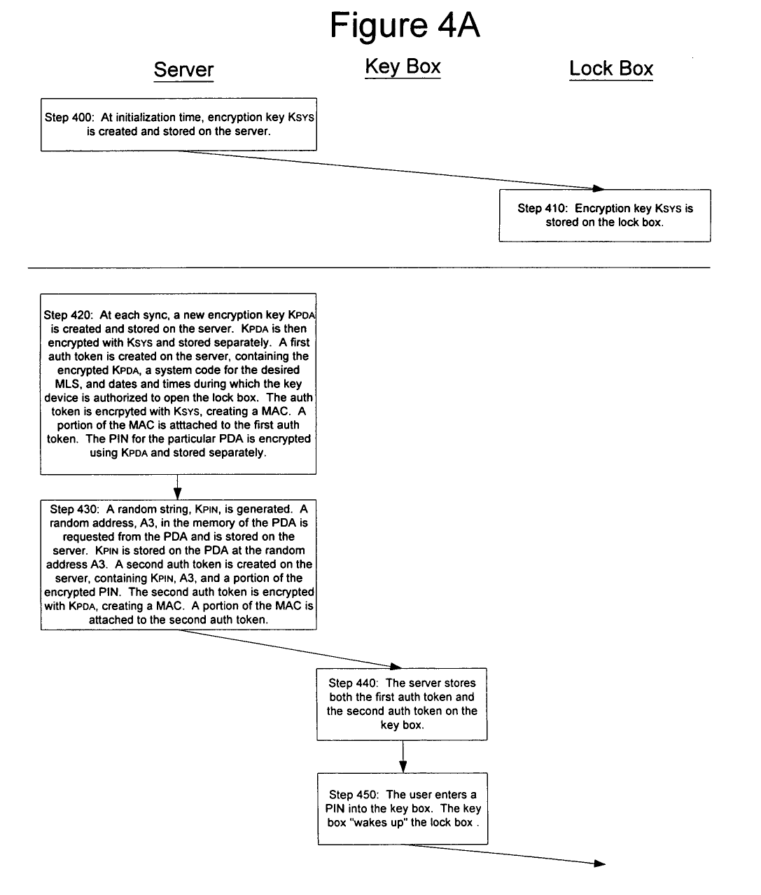

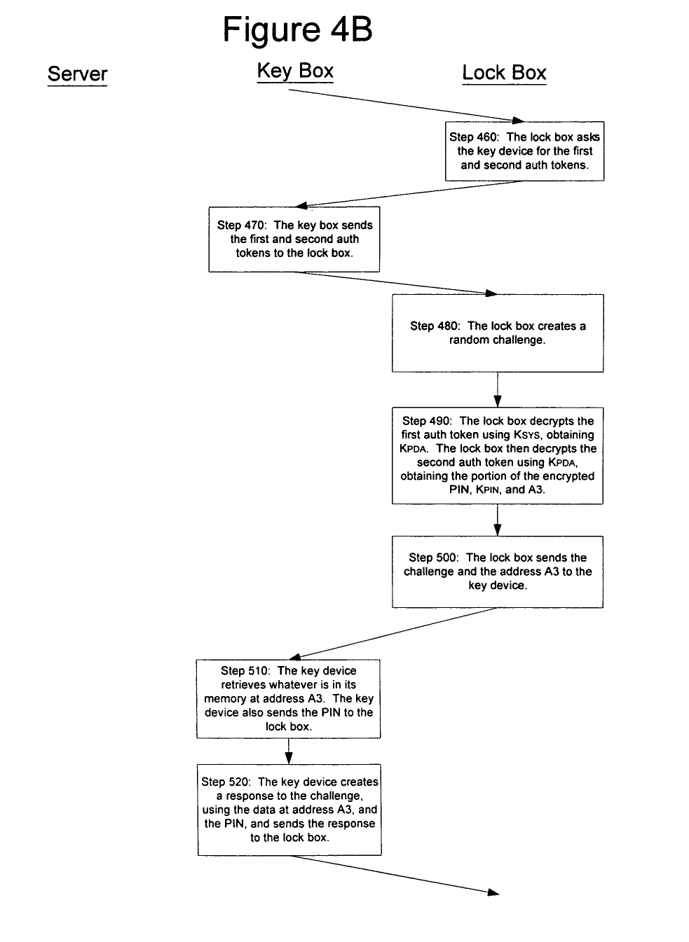

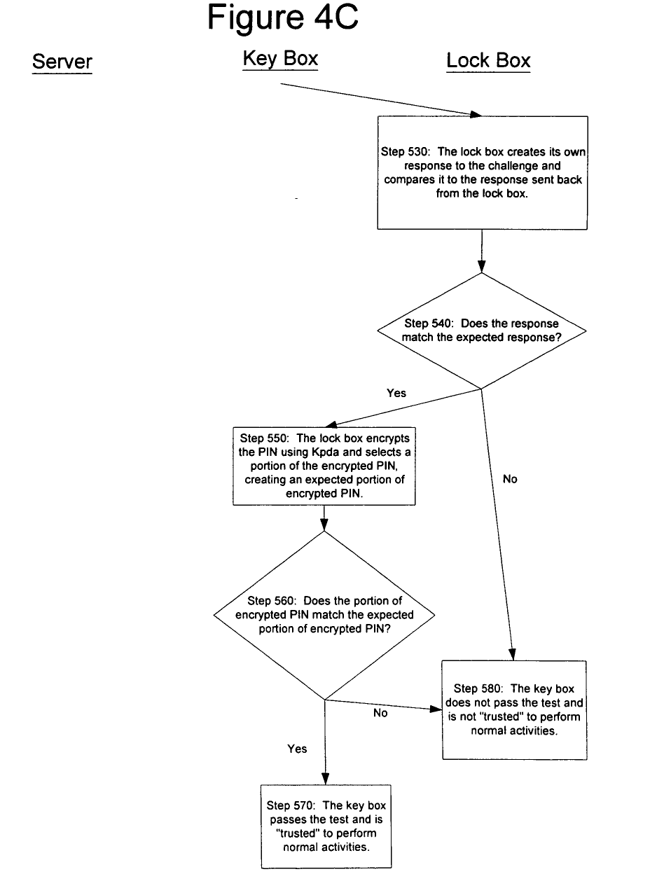

Another of the techniques used to combat unauthorized opening of a lock box is that the key device carries messages from the server to the lock box that the key device itself cannot itself read. These messages, in turn, are used to verify that the key device has not been tampered with. In particular, and as shown in FIG. 4 (comprising subparts FIGS. 4A, 4B, and 4C), in step 400 the server creates a system encryption key K_{SYS} and stores it on the server. The server can support a plurality of system keys; for instance, a unique K_{SYS} can be assigned to each Multiple Listing Service (MLS).

In step 410, when a lock box is created at the factory, a particular K_{SYS} is programmed into it, e.g. the lock box is assigned to a particular MLS. The K_{SYS} is, preferably, stored in EEPROM associated with the CPU 250 of the lock box.

The remaining steps in FIG. 4 may occur a plurality of times. In step 420, which occurs at each sync between the server and a key device, the server creates a second encryption key, K_{PDA}, and stores it on the server. The server then encrypts K_{PDA} with K_{SYS} and creates a first authorization token, containing the encrypted K_{PDA}, a system code for the desired MLS, and dates on which the key device is authorized to open the particular lock box; encrypts the authorization token with K_{SYS}, thereby creating a MAC; and attaches a portion of the MAC to the first authorization token. Using only a portion of the MAC is another security feature of the present system, as, even if a malefactor could figure out the encryption key and/or the MAC, he would also have to figure out which portion of the MAC is used. The first authorization token is then stored on the server.

The server also encrypts the PIN stored on the server for the particular PDA using K_{PDA}, and stores the encrypted PIN on the server separately from the unencrypted PIN.

In step 430, the server creates a third encryption key, K_{PIN}, and stores it on the server. The server then asks the key device to select a random address A3 in the memory of the PDA and communicate the address A3 to the server. The server then stores the third encryption key K_{PIN} on the key device at the address A3, and stoles the address A3 on the server. At no time is the random address A3 in the memory of the key device pointed to or used by any other application, making detection or discovery by an outsider extremely difficult.

The server then creates a second authorization token, containing a portion of the encrypted PIN, K_{PIN}, and A3; encrypts the second authorization token with K_{PDA}, thereby creating a MAC; and attaches a portion of the MAC to the second authorization token. The second authorization token is then stored on the server.

In step 440, the server stores both the first authorization token and the second authorization token on the key device. Because they are encrypted, the key device cannot read either of the authorization tokens.

In step 450, a real estate agent takes the key device to a lock box of a home she wishes to visit, enters her personal identification number (PIN) into the key device, and “wakes up” the lock box. This “waking up” preferably occurs by infrared communication, although other forms of communication, including RF, electrical, and mechanical communication among others, are also within the scope of the present system.

In step 460, the lock box asks the key device for the first and second authorization tokens.

In step 470, the key device sends the first and second authorization tokens to the lock box.

In step 480, the lock box creates a random string of data, known as a random challenge. The random challenge is preferably based on the real-time clock component of the lock box, though other techniques for creating random strings of data are also within the scope of the present system.

In step 490, the lock box decrypts the first authorization token using K_{SYS}, which was programmed into the lock box at the factory (step 410 above). Upon decrypting the first authorization token, the lock box obtains K_{PDA} and other information stored in the first authorization token. The lock box then uses K_{PDA} to decrypt the second authorization token, thus obtaining the portion of the encrypted PIN, K_{PIN}, and A3.

In step 500, the lock box sends the challenge and the address A3 to the key device.

In step 510, the key device obtains data from its memory at address A3. The key device also sends the PIN to the lock box.

In step 520, the key device uses the data at address A3 to encrypt the challenge and the PIN, thereby creating a response, then sends the response back to the lock box. As noted, the response is created according to an algorithm stored on the key device, for which the inputs are preferably the challenge, the key used to decrypt the challenge, the address A3, and the PIN, though more or fewer elements may also be used.

In step 530, the lock box creates its own response to the challenge. The response must be created using the same algorithm used on the key device, for which the inputs are preferably the original challenge, K_{PIN}, the address A3, and the PIN passed to the lock box by the key device. The lock box then compares the response it just created with the response it obtained from the key device in step 520.

In step 540 the lock box decides whether the two responses are the same. If they are the same, this is a good indication that the PDA has not been tampered with, that the PDA that has been presented to the lock box has not been copied from another PDA. In step 550, the lock box then uses K_{PDA} to encrypt the PIN sent by the key device and selects a portion thereof, thereby creating an expected portion of encrypted PIN. In step 560, the lock box compares the expected portion of encrypted PIN with the encrypted portion of the PIN in the second authorization token. If this second comparison also results in a match, i.e., the PDA passes both tests, then, in step 570, the PDA is “trusted” to perform normal processing, and processing continues.

If, however, the PDA fails either of the two tests, i.e., at least one of the two comparisons in steps 540 and 560 does not result in a match, this is a good indication that the memory of the PDA has been tampered with since the last sync, or that the memory of the PDA being presented to the lock box was copied from the memory of another PDA and the copied data did not go to exactly the same address (which is usually the case when copying from one PDA to another), or that the user does not have the correct PIN. In that case, in step 580, the PDA does not pass the test and is not “trusted” to perform normal processing.

Key Device

As discussed above, the key device used in the present system is, preferably, an open-architecture PDA. Several software applications in accordance with the present system may reside on the PDA for interaction with the server and with a lock box. As discussed above with relation to server-key device and key device-lock box communication, a technique is needed for a user of a given key device to verify that the memory of the PDA has not been tampered with.

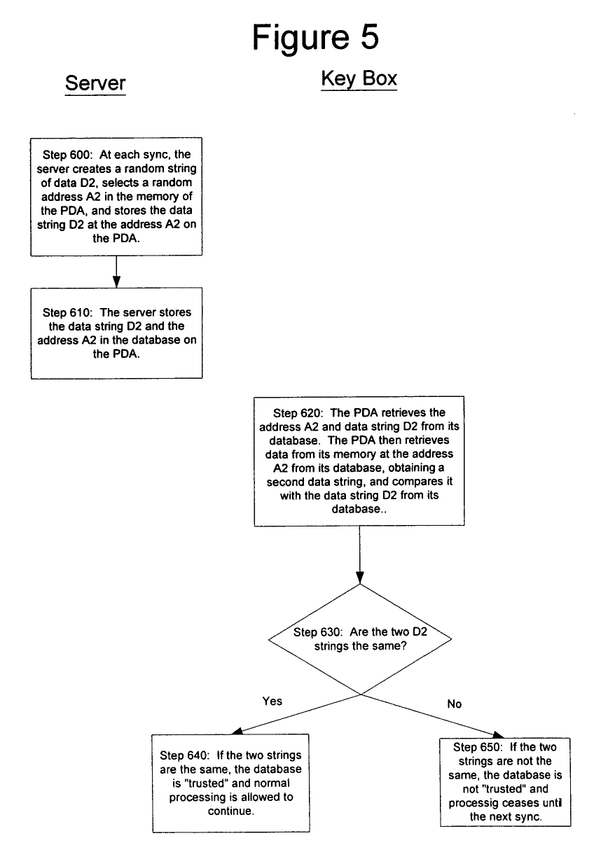

Turning now to FIG. 5, in step 600, at each sync the server creates a random string of data D2, selects a random address A2 in the memory of the PDA, and stores the data string D2 at the random address A2.

In step 610, the server stores the string D2 and the address A2 in the database on the PDA.

In step 620, the PDA retrieves the data string D2 and the address A2 from its database, retrieves a data string from its memory at address A2, and compares the two data strings (i.e. the data string D2 from its database and the string retrieved from its memory at address A2).

In step 630, the PDA asks whether the two strings are the same. If they are the same, then in step 640 the database on the PDA is “trusted” and normal processing continues. If the two data strings are not the same, this indicates that the PDA has been tampered with or has been copied from another PDA, and in step 650 normal processing is not allowed until the next sync between the PDA and the server.

Lock Box Features

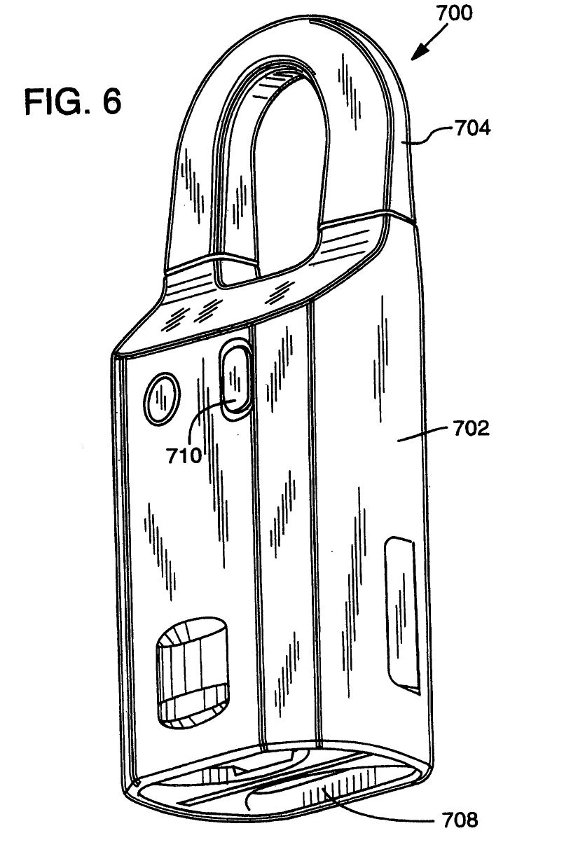

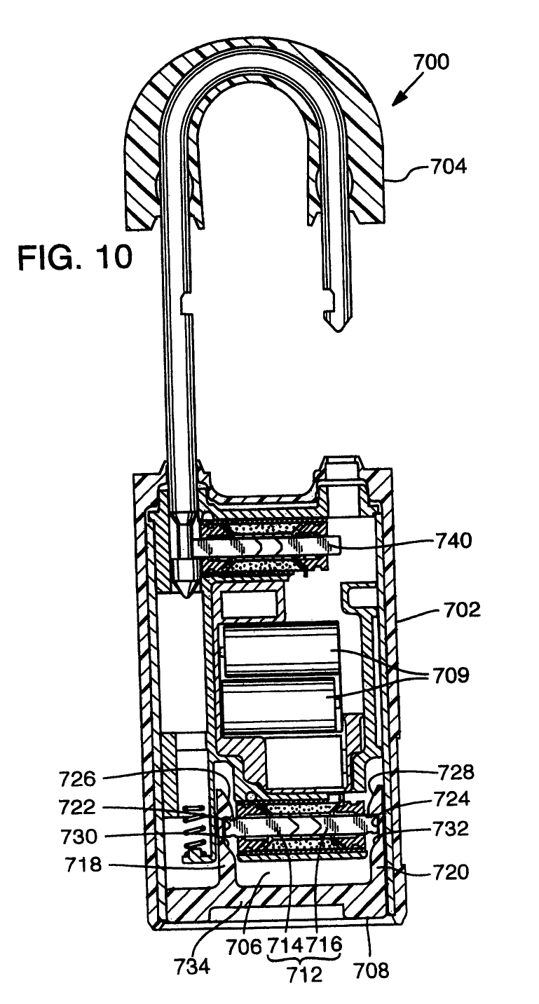

An exemplary lock box 700 is shown in FIG. 6. The lock box 700 has a body 702 and a shackle assembly 704. One end of the shackle assembly 704 can be unlocked (see FIG. 10) to allow the lock box 700 to be attached to a door or other secure object.

Within the body 702, a recess. 706 is defined. A key container 708, shown in its secured position in FIG. 6, is received within the recess 706. The key container 708 has a secure storage area typically used to store one or more conventional keys (not shown).

As described above, the lock box 700 interacts with key devices via infrared communication. An infrared transceiver 710, which is connected to a circuit with a central processing unit and a memory, allows the lock box 700 to send and receive signals.

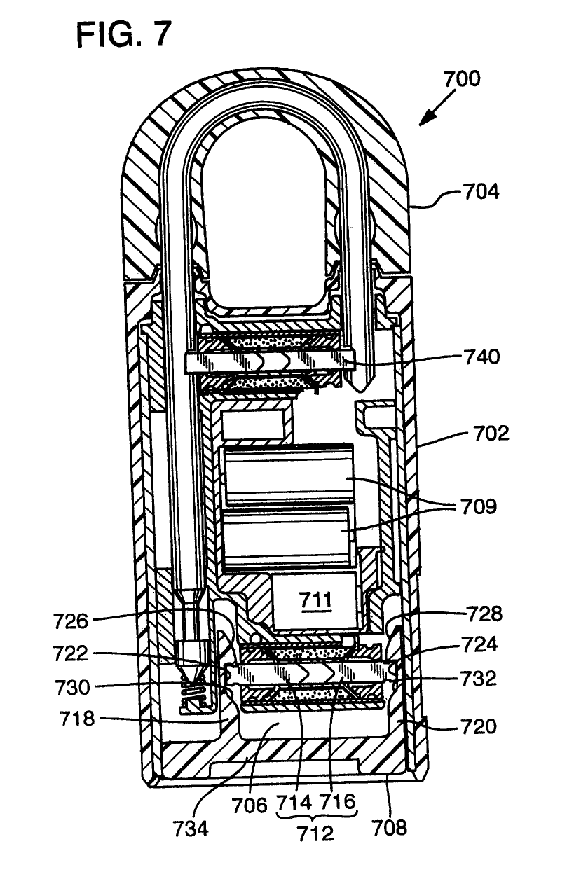

FIGS. 7, 8, and 9 are cross-sections of the lock box 700 of FIG. 6, and show some of the internal components of the lock box 700. In the illustrated implementation, there are two batteries 709. A capacitor 711 is connected to the batteries 709 and stores a charge for energizing solenoids 712 and 740, which are described below.

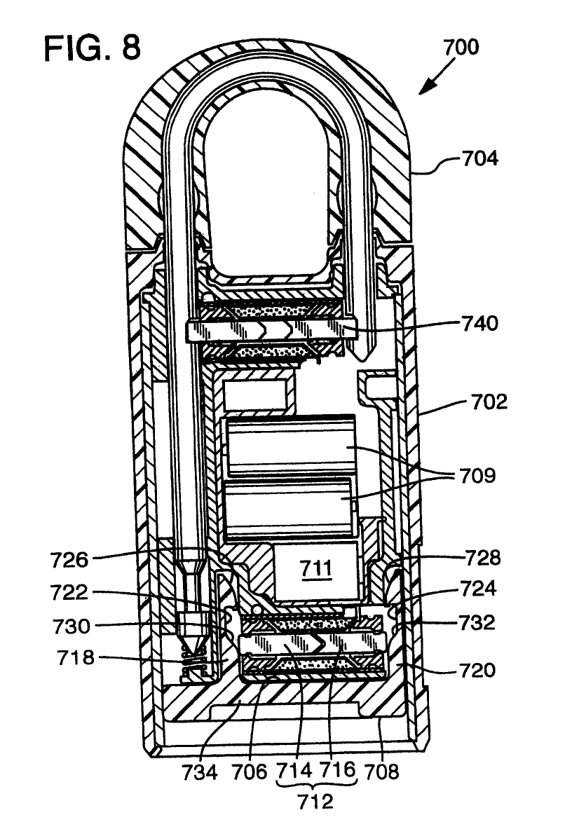

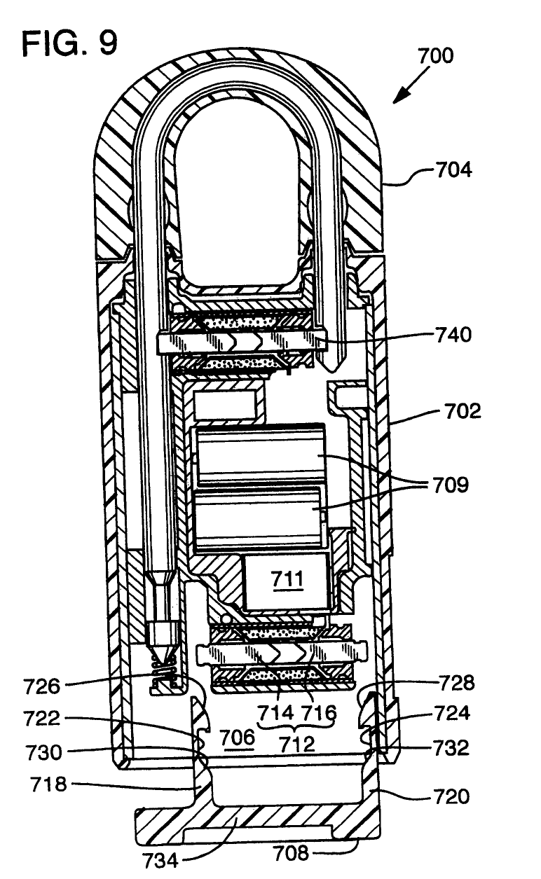

In FIG. 7, the key container 708 is shown in its secured position received in the recess 706. In FIG. 8, the key container 708 is shown in is pre-release position. In FIG. 9, the key container 708 is shown in its released position.

Referring to FIG. 7, the key container 708 is secured by a dual-acting solenoid 712. The solenoid 712 has a male part 714 and a corresponding female part 716, which, when not energized, move axially away from each other and occupy the position shown in FIG. 7 to secure the key container 708.

The key container 708 has first and second arms 718, 720 with respective notches 722, 724 and respective ramped ends 726, 728. In the secured position, the male part 714 is engaged in the notch 722, and the female part 716 is engaged in the notch 724, as shown in FIG. 7.

The notches 722, 724 have angled solenoid engagement sections 730, 732, respectively. During an access routine in which the lock box 700 has received an authorized request to access the key container 708 (e.g., an Obtain Key command), the inductance between the male part 714 and the female part 716 is monitored.

Referring to FIG. 8, the key holder who made the authorized request (not shown) has pushed upward on a bottom portion 734 of the key container 708, which causes the solenoid engagement sections 730, 732 to engage the male part 714 and the female part 716, respectively, and to urge them toward each other. When the male part 714 and the female part 716 are closer together, the monitored inductance increases. The change in inductance is used to trigger activation of the solenoid 712.

When the solenoid 712 is activated, the male part 714 and the female part 716 are held together by magnetic force, the arms 718, 720 are disengaged, and the key container 708 is released as shown in FIG. 9. A display (not shown) may prompt the key holder with instructions and provide other information throughout the process.

As described, the solenoid 712 does not require a separate switch for activation. Rather, the inductance in the male and female parts 714, 716 is sensed and the solenoid is activated when a predetermined inductance level (in this case a higher inductance) is reached. This design helps reduce power consumption, as the solenoid 712 is only activated when the male and female parts 714, 716 are close together.

The solenoid 740 secures the shackle assembly 704, and can be energized by a Release Shackle command to retract and allow the shackle assembly to be released as shown in FIG. 10. The solenoid 740 can be configured as conventional solenoid as shown in the figures, or, depending upon the specific configuration of the lock box 700, as a power saving solenoid similar to the solenoid 712.

### Conclusion

It is to be recognized that the illustrated embodiments are only examples and should not be taken as a limitation on the scope of the invention. Rather, the invention is defined by the following claims.

We claim:

1. A security system, comprising:
an electronic lock at a remote location, the electronic lock having a memory in which a first encryption key is stored; and
a portable electronic key device, the portable electronic key device coupleable to the electronic lock and operable by a key device user to open the electronic lock, the portable electronic key device having a memory in which data protected by the first encryption key is stored,
wherein:
when the key device user couples the portable electronic key device and the electronic lock, the encrypted data is sent from the portable electronic key device to the electronic lock and the electronic lock attempts to decrypt the encrypted data using the first encryption key, and
the first encryption key is not stored in the memory of the key device,
whereby the lock opens if the attempted decryption succeeds.

2. In a real estate lock box system comprising a server, a key device, and a lock box, the lock box containing a key to a real estate property, the lock box opening to reveal the key upon verifying the identity of the key device, an improvement comprising using an open architecture computer device as the key device.

3. The system of claim 2 wherein the open architecture computer device is a personal digital assistant.

4. The system of claim 2 wherein the open architecture computer device is a personal digital assistant having a memory in which encrypted credentials information is stored, the encrypted credentials information being communicated to the lock box when access to the lock box is desired.

5. In a real estate lock box system comprising a server, a key device, and a lock box, the lock box containing a key to a real estate property, the lock box opening to reveal the key upon verifying the identity of the key device, an improvement comprising verifying the identity of the key device using data protected by a message authentication code.

6. The system of claim 5 wherein only a portion of the message authentication code is used.

7. In a real estate lock box system comprising a server, a key device, and a lock box, the lock box containing a key to a real estate property, the lock box opening to reveal the key upon verifying the identity of the key device, an improvement comprising the lock box verifying authorization of the key device to interact with the lock box using data protected by a message authentication code.

8. The system of claim 7 wherein the data comprise authorization codes used to distinguish Multiple Listing Services.

9. The system of claim 7 wherein the data comprise authorization codes used to distinguish lock boxes.

10. The system of claim 7 wherein the data comprise authorization codes used to determine the dates and times at which the key device is authorized to access the lock box.

11. The system of claim 10 wherein the data expire at a pre-determined date and time.

12. The system of claim 11 wherein the expiration date and time are updatable to different dates and times.

13. The system of claim 7 wherein the intermediary is identified by a personal identification code (PIN),
the PIN is encrypted by the server; and
the data comprise a portion of the encrypted PIN.

14. The method of claim 13 wherein:
the server and the intermediary communicate with each other periodically to exchange information, and
the PIN is changeable during each communication between the server and the intermediary.

15. A method of validating an intermediary in a system, the system comprising a server, the intermediary, and a client, the intermediary having a memory, the method comprising the steps of:
creating a first encryption key;
storing the first encryption key on the server and on the client;
creating a second encryption key;
storing the second encryption key on the intermediary at a random memory address, wherein the random memory address is not known to the intermediary;
storing the random memory address of the intermediary on the server;
encrypting the random memory address and the second encryption key on the server using the first encryption key;
passing the encrypted random memory address and the encrypted second encryption key from the server to the intermediary;
passing the encrypted random memory address and the encrypted second encryption key from the intermediary to the client;
decrypting the random memory address and the second encryption key on the client using the first encryption key;
creating a random challenge on the client;
passing the challenge and the memory address from the client to the intermediary;
obtaining data from the memory of the intermediary at the memory address;
encrypting the challenge on the intermediary using the data obtained from the memory address;
passing the encrypted challenge from the intermediary to the client;
encrypting the challenge on the client using the second encryption key; and
comparing the encrypted challenge passed from the intermediary to the client with the encrypted challenge created on the client.

16. The method of claim 15 wherein:
the client further has a real-time clock, and
the random challenge is based on the real-time clock.

17. A method of validating an intermediary in a system, the system comprising a server, the intermediary, and a client, the intermediary having a memory, the client having a central processing unit and a memory, the memory of the client having a secure area, the method comprising the steps of:
creating a first encryption key on the server;
storing the first encryption key on the client;
creating a second encryption key on the server;
storing the encrypted second encryption key in a first authorization token on the server;
encrypting the first authorization token using the first encryption key on the server, thereby generating a first server message authentication code (MAC);
passing the first authorization token and a portion of the first server MAC from the server to the intermediary;
creating a third encryption key on the server;
storing the third encryption key on the intermediary at a random first memory address;
encrypting the third encryption key and the first memory address using the second encryption key on the server;
storing the encrypted third encryption key and the first memory address in a second authorization token on the server;
encrypting the second authorization token with the second encryption key, thereby generating a second server MAC;
passing the second authorization token and a portion of the second server MAC from the server to the intermediary;
passing the first memory authorization token, the portion of the first server MAC, the second authorization token, and the portion of the second server MAC from the intermediary to the client;
using the first encryption key to decrypt the first authorization token on the client, obtaining the second encryption key;
verifying the first authorization token on the client by generating a first client MAC and comparing a portion of the first client MAC with the portion of the first server MAC;
using the second encryption key to decrypt the second authorization token on the client, obtaining the first memory address and the third encryption key;
verifying the second authorization token on the client by generating a second client MAC and comparing a portion of the second client MAC with the portion of the second server MAC;
creating a challenge on the client;
passing the challenge and the first memory address from the client to the intermediary;
obtaining data from the memory of the intermediary at the first memory address;
combining the challenge, the first memory address, and the data from the memory of the intermediary at the first memory address, creating a response therefrom;
passing the response from the intermediary to the client;
combining the challenge, the first memory address, and the third encryption key on the client, creating an expected response therefrom;
comparing the response with the expected response, and
validating the intermediary if the response matches the expected response.

18. The method of claim 17 wherein the first encryption key is stored in the central processing unit of the client.

19. The method of claim 17 wherein:
the server and the intermediary communicate with each other periodically to exchange information, and
each of the encryption keys other than the first encryption key is changeable during each communication between the server and the intermediary.

20. The method of claim 19 wherein the server and the intermediary communicate at least daily in a synchronization process.

21. The method of claim 17 wherein:
the client further has a real-time clock, and
the random challenge is based on the real-time clock.

22. A method of protecting against copying in a system, the system comprising a server and an open architecture computer device, the open architecture computer device having a memory, the method comprising the steps of:
at initialization time:
creating a random string of data on the server;
storing the random string of data on the server;
storing the random string of data on the client at a random address in the memory of the open architecture computer device, wherein the random address is not known to the open architecture computer device;
storing the random address on the server; and at verification time,
passing the random address from the server to the open architecture computer device;
obtaining data from the memory of the open architecture computer device at the random address;
passing the data obtained from the memory of the open architecture computer device to the server;
comparing the data passed from the open architecture computer device to the server with the random string of data stored on the server, and
determining that copying has not occurred if the data passed from the open architecture computer device matches the random string of data stored on the server.

23. The method of claim 22 wherein, upon determining that copying has not occurred, the initialization time steps are performed in preparation for the next verification time.

24. A real estate lock box comprising a container that holds a key, a central processing unit that determines whether an individual seeking access to the key container is authorized to gain such access, and a memory, wherein the memory is partitioned into a first area and a second area, the first area containing unprotected public information and the second area containing secure information that requires authorization to access.

25. The real estate lock box of claim 24 wherein a device-unique identification code is associated with the lock box.

26. The real estate lock box of claim 25 wherein the device-unique identification code is stored in the central processing unit.

27. The real estate lock box of claim 25 wherein the device-unique identification code is used to give permission to reprogram the central processing unit.

28. The real estate lock box of claim 27 wherein the permitted reprogramming includes changing the device-unique identification code.

29. The real estate lock box of claim 24 wherein static data are loaded into the first memory area for public access.

30. The real estate lock box of claim 29 wherein the static data include listing information for a real estate property associated with the lock box.

31. The real estate lock box of claim 24 wherein data are generated upon each access to the first memory area and the generated data are stored in the first memory area for public access.

32. The real estate lock box of claim 31, wherein the information stored in the first memory area comprises a log of users who have accessed the first memory area.

33. The real estate lock box of claim 24 further comprising a solenoid that secures the key container within the lock box, the solenoid having two opposing parts and being actuatable in response to a sensed inductance level in the parts, wherein when the parts are moved toward each other, the sensed inductance level reaches a predetermined value and the solenoid is actuated to release the container and allow access to the key.

34. A real estate lock box having a key container secured by a solenoid with opposing first and second members, the first and second members being spaced apart when the key container is secured, wherein the key container is shaped to move the first and second members toward each other, thereby changing the inductance in the members and triggering actuation of the solenoid.
